(19) United States
(12) Patent Application Publication
(10) Pub. No.: US 2004/0083782 A1
(43) Pub. Date: May 6, 2004

(54) Security container lock with tamper-evident seal

(76) Inventor: Paul D. Lantz, Kingston, PA (US)

Correspondence Address: Bradley N. Ruben, Suite 5A, 463 First Street, Hoboken, NJ, 07030, US

(21) Appl. No.: 10/288,979

(22) Filed: Nov. 6, 2002

(51) Int. Cl. E05B 67/38; E05B 13/02; E05B 17/14

(52) U.S. Cl. 70/423; 70/68

(57) ABSTRACT

A tamper-evident seal is provided in combination with a keyed lock so that the seal prevents full accessability to the keyhole. The combination is especially suitable for security bags, and is applicable to any keyed lock.

### BACKGROUND OF THE INVENTION

1. Field of the Invention

The invention relates to a lock used especially with flexible-walled security containers, the lock having a seal to indicate tampering.

2. The State of the Art.

Flexible-walled security containers are typically employed by banks and other institutions for carrying valuables. The type of containers to which the present invention particularly pertains are disclosed, for example, in prior U.S. Pat. Nos. 3,759,073, 5,013,162, and 5,065,602, the disclosures of which are incorporated herein by reference.

The security container disclosed in the '073 patent includes a flexibly walled bag open along one or more sides and having a slide fastening closure along the opening. The container is equipped with a locking mechanism, shown in FIGS. 1 and 2, which includes a body 11 located partly within the bag and having a receiver or jaw 20 that receives a slider (not shown) of the closure when the slider closes the opening of the bag. The receiver extends from an inner end surface 13 of the body 11 and is provided with a generally horseshoe-shaped recess 22. A necked passageway 25 is provided from the recess through one end 24 of the receiver to receive the slider. The recess and necked passageway are shaped to conformably receive and retain the slider. A movable retainer 32 is supported on the body and includes a plate 33 movable towards and away from the recess. After the slider is received in the recess, the plate can be locked down on top of the slider. A pair of lugs 30 on opposing sides of the passageway project upwardly from the receiver towards the plate. The lugs are intended to prevent removal of the slider from the recess without raising the slider above the lugs, and so the lugs and the plate together form an enclosure for the slider.

In the '073 patent, gaps are provided between the lugs and the inner end surface 13 of the body, on the upper surface 21 of the receiver. It was originally thought that these gaps would assist in permitting the engagement of the slider in the recess without criticality as to the slider position, for speed, convenience and ease of operation. Instead, it has now been found that the presence of these gaps is not particularly critical to the positioning of the slider in or its removal from the recess. Further, those gaps are the largest remaining openings in the locking mechanism which surrounds the slider when the slider is secured in the recess. In the '162 patent, as shown in FIGS. 3 and 4 of the instant application, a clip 100 was provided for mounting on to the receiver to cover the gaps with a pair of rolled portions, 108 and 109, that slipped over the corresponding lugs and, when the clip was in place, extended from the lug to the inner end surface. In a different embodiment, the above-referenced '602 patent, as shown in FIG. 10 of the instant application, includes lugs 44 depending from the retaining mechanism and positioned (when the retaining mechanism is closed) between in the gaps.

In all of the foregoing patents, the retainer and accompanying plate are maintained in and released from the locked position by means of a keyed locking mechanism. Prior art devices, such as that disclosed in U.S. Pat. No. 4,661,990, utilize a metal or plastic hood over a corner of the bag and adapted to receive the slider, with a tab extending and registering with the slider and the hood. While such mechanisms are adequate for securing the container in a locked position, the use of many key-locked security containers in an organization means that often multiple keys, including master keys, can be available to multiple people. In addition, with a large number of common keys available, the opportunity to copy the key is increased. Still further, there is the possibility that the lock could be compromised (picked) without the knowledge of any of the security personnel. Accordingly, it would be beneficial to provide a security container with a keyed lock that evidenced tampering.

### SUMMARY OF THE INVENTION

In one embodiment the invention comprises a flexible bag having an opening that is closed and reopened by a slider, a keyed locking mechanism to retain the slider in the closed position, and a seal positioned to interfere with unlocking the mechanism by key.

In operation, the seal must be compromised to gain access to the key hole or to be able to turn the key to unlock the mechanism. After the bag is opened it is reclosed, relocked, and a new seal is secured to interfere with the keyed lock.

In more general embodiments, the invention provides a seal that must be compromised (for example, removed, bent, or broken) to physically access a lock mechanism, such as a keyed lock or a number pad, and the seal providing evidence of such compromise.

### BRIEF DESCRIPTION OF THE DRAWINGS

FIG. 1 depicts the locking mechanism of U.S. Pat. No. 3,759,073 in a locked condition.

FIG. 2 depicts the locking mechanism of U.S. Pat. No. 3,759,073 in an open or unlocked condition.

FIG. 3 depicts a partially broken-away isometric view of the locking mechanism of U.S. Pat. No. 5,013,162 in a locked condition.

FIG. 4 depicts a partially broken-away and partially exploded view of the locking mechanism of U.S. Pat. No. 5,013,162 in an unlocked condition.

FIG. 5 is a plan view of one embodiment of a seal used in this invention.

FIG. 6 is a plan view of the locking mechanism of this invention having the seal of FIG. 5 in place.

FIG. 7 is a plan view of the locking mechanism of this invention having a different embodiment of a seal.

FIG. 8 is a cross-sectional view of the locking mechanism shown in FIG. 6 or FIG. 7 without the seal in place and in the unlocked position.

FIG. 9 is an embodiment of a locking mechanism, and FIG. 10 is a cross-sectional view therethrough with a slider retained therein.

FIG. 11 is an embodiment similar to those shown in FIGS. 6 and 7, wherein the seal allows access to the keyhole but interferes with the turning of the key.

### DETAILED DESCRIPTION OF SPECIFIC EMBODIMENTS

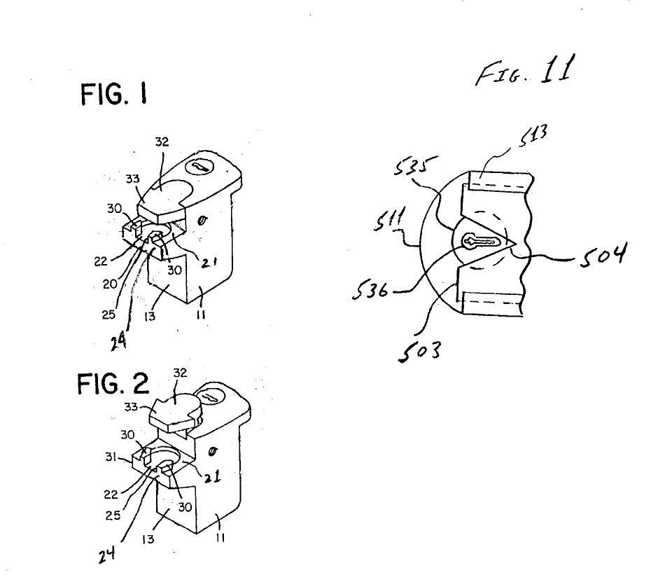

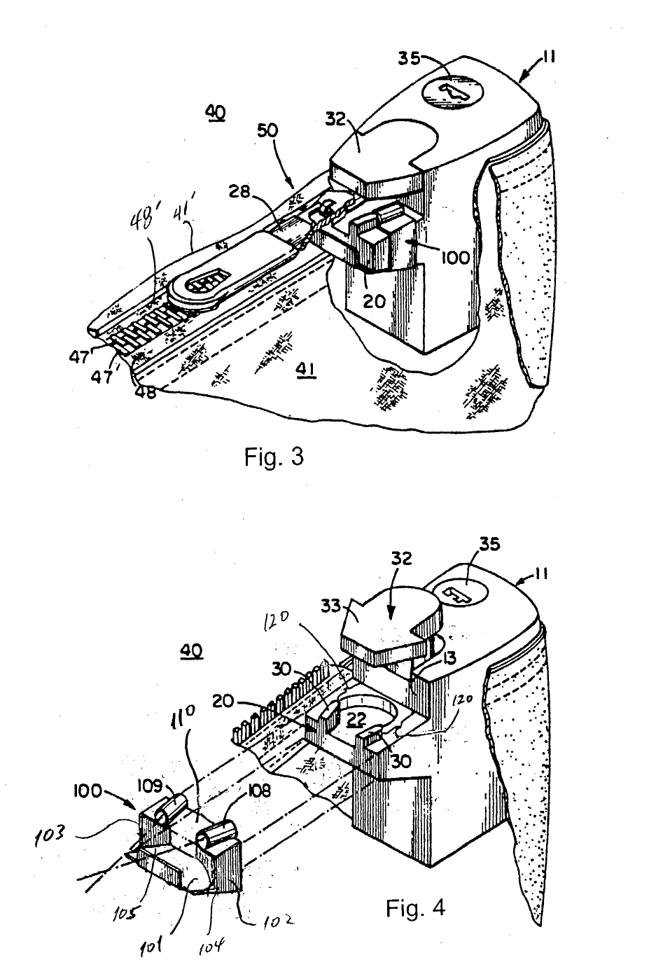

Referring to FIGS. 1 and 2, a suitable locking mechanism for a security bag includes a body 11 having slidable therein a retainer 32, slidable between an open position as shown in FIG. 2 and a closed position as shown in FIG. 1. The face plate 33 of the retainer cooperates a receiver 20 that includes a platform 31 defined by a pair of wings separated by a recess 22. The recess is separated from the wings at the distal end by a pair of projections or lugs 30, between which is a passage 25 leading to the recess. As shown in FIGS. 3 and 4, such a locking mechanism can be used with a flexible security bag (although the particular locking mechanism shown in those figures is different).

Referring to FIGS. 3 and 4, from the '162 patent, a flexible-walled security container is indicated generally at 40 and includes a pair of flexible walls 41 and 41′, edge margins of which are indicated generally at 47 and 47′. The edge margins 47, 47′ are provided by flexible slide fastener tapes indicated at 48 and 48′, respectively. In addition to forming the edge margins, tapes 48 and 48′ comprise parts of a slide fastener means indicated generally at 50. An opening is provided between the edge portions 47 and 47′ when the teeth of the tapes 48 and 48′ are disengaged. The fastener means 50 further includes a slider 28 shiftable along the tapes 48, 48′ and edge margins 47, 47′ to open and close the opening. The clip of the aforementioned '162 patent is indicated at 100.

The improvement of the '162 patent invention is the provision of a clip which is indicated generally in FIGS. 3 and 4 at 100 and is mounted to the receiver 20 covering the gaps 120. Referring particularly to FIG. 4, the clip includes a base 101 and a pair of arms 102 and 103 integral with the base 101 extending generally transversely from the base 101, in the same direction, from a pair of opposing sides 104 and 105 of the base, which extend up from the base and form therebetween a gap 110. Portions 108 and 109 formed adjacent the top of the gap are preferably doubled over, preferably by being rolled, to project in a direction that cooperates with the lugs and gaps 30 (as explained later). Where the portions 108 and 109 are rolled, the roll thereby defining an axis, the respective axes are preferably converging, but may be parallel. Still referring to FIGS. 3 and 4, arms 102 and 103 with rolled portions 108 and 109 extend transversely from the base 101 sufficiently to cover the gaps 120 between lugs 30 and inner end surface 13 (comparing FIGS. 3 and 4) when the clip is put in place. Preferably, the clip 100 is cut and formed from a hardened spring steel.

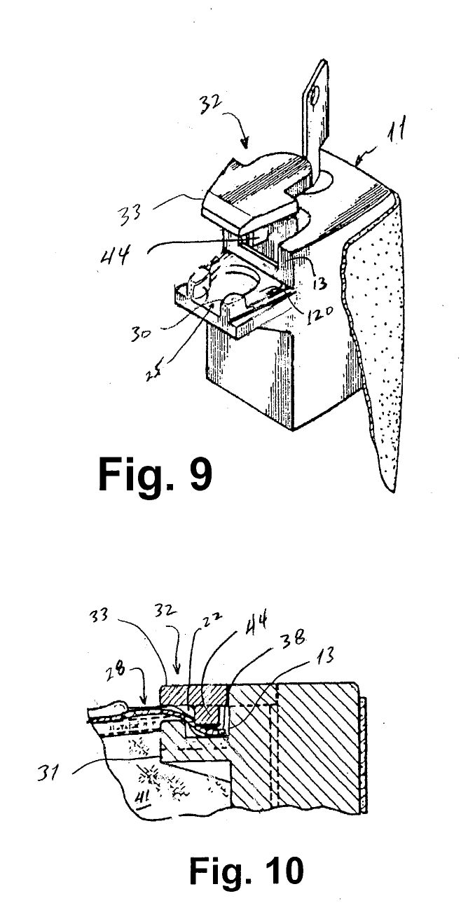

In the embodiment of a locking mechanism shown in FIGS. 9 and 10, the above-referenced '602 patent uses a second pair of lugs 44 depending from the plate 33 and engaging the space 120 between the lugs 30 and the back 13. A pull and slider 28 (such as the pull of a zipper-type closure) extends through the passage 25 into the recess 22, and is frictionally retained in the recess by a combination of the passage preferably being narrower than the width of the recess, and by the engaging arrangement of the upstanding lugs 30 and the platform 31 with the depending lugs 44 and the plate 33. The lugs prevent the ends of the tape from being pulled apart and through the gaps 120, which can then provide access to the bag.

The foregoing locking mechanisms are those preferred for flexible security bags, and so the present invention is described with reference thereto. However, this invention is applicable to any keyed lock, as well as other non-keyed locks where it is necessary or desirable to determine whether the keyhole has been accessed.

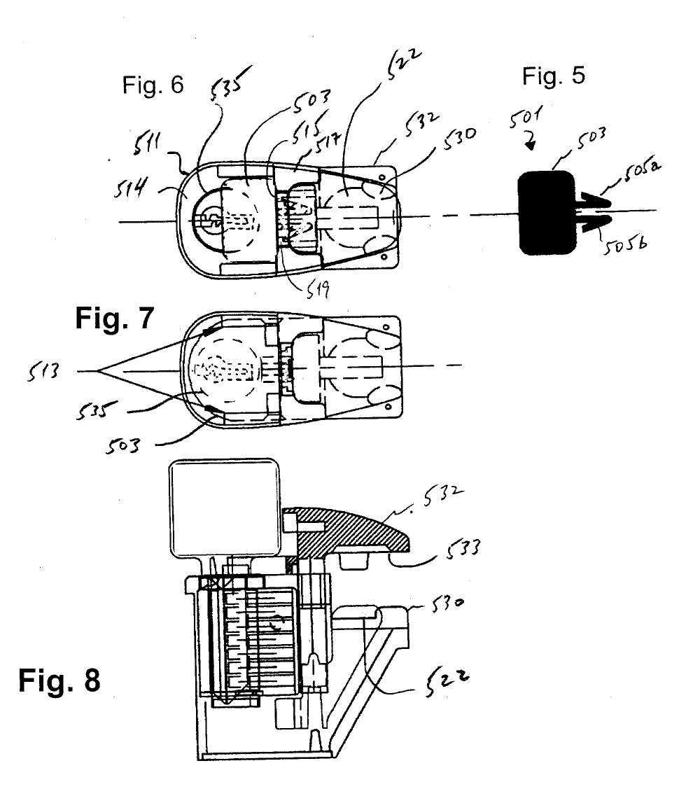

One embodiment of the seal of the present invention is shown in FIG. 5, where the seal 501 generally comprises a body 503 and a pair of spring-snaps or spring-pawls 505a and 505b; although unlike a true pawl, the seal is designed to allow removal (disengagement of the pawls) only by at least partially destroying or compromising the integrity of the seal. The body may be made of metal, plastic, or a combination of the two. For example, the body may be made of plastic but the keyed lock (discussed below) can be made of metal; or the body may be made of metal and the lock made of plastic. The seal is preferably made of plastic, preferably between about 1/16″ and ⅛″ (about 1.5 mm to 3.2 mm) in thickness.

FIG. 6 is a top view of the locking mechanism of this invention, comparable to those shown in FIGS. 1-4, the last two digits of the reference numerals being the same for corresponding structure shown in those figures. The lock body 511 houses the keyed lock 535 includes the top surface 514 of the body. A passage 515 contiguous with the top surface is created by opposing guides 517 extending up from the lock body. The seal is placed on the surface and slid so that the spring-snaps enter the passage and engage a pair of opposing shoulders 519 to retain the seal in at least partly overly relation to the keyed lock, as shown. The snaps prevent the seal from being removed by being slid back. The function of the seal is to prevent a key from being inserted into the keyed lock without an indication that the lock has or may have been opened. Thus, the seal is made so that it can be broken away from the lock body (or bent away in the case of a metal seal) and removed, thereby exposing the entire keyhole, so that if a user receives a device where the seal is missing or broken, or where numbered seals are used the number is different than expected, the user is made aware that someone tampered with the lock and/or the contents. (With numbered seals, for example, the number of the seal can be sent (mailed, emailed) to the recipient so that the recipient can compare the number received with the number of the seal on the lock.) In the embodiment shown in FIG. 7, the seal is slid under L-shaped flanges 513 as an added precaution against the seal being accidently broken during handling (the flanges protect the seal), and the seal fully covers the keyhole.

FIG. 8 is a cross-sectional side view of the unlocked device with a key inserted into the keyhole, and having the corresponding lugs 530, and the retainer 532 and plate 533 cooperating with recess 522 as in the above-mentioned patents.

The locking mechanism may be housed within a chamber so that access to the lock requires opening the chamber (such as chambers sold under the TEBCO brand by A. Rifkin Co., Wilkes-Barre, Pa.). In such cases, a seal can be used to secure the opening to the chamber, and another can be positioned over the keyhole to the lock accessed by opening the chamber.

FIG. 11 is a view of an embodiment where a lock body 511 having flanges 513, as shown in FIGS. 6 and 7, includes a seal 503 having an opening 504 that allows a key to be inserted into the keyhole 536 of the keyed lock 535, but otherwise prevents an inserted key from being turned effective to open (or to secure) the lock. In this figure, the key can only be turned within the open region, the seal preventing rotating the key more than about 30° in either direction.

Although shown with two prongs, it is sufficient if the seal has or accepts a catch, such as a pawl, but unlike a pawl designed to be disengaged only by at least compromising the integrity of the seal. The seal shown in FIG. 5 has two catches. Various other pawl type catches are well-known in the art (and some are commercially available from A. Rifkin Co., Wilkes-Barre, Pa.). For example, catches may extend from a central stem rather than separate stems, or instead of the hook-like part of the catch facing outwardly as in FIG. 5, it may face inward towards the other catch. It may also be possible to design an interference fit such that the seal cannot be removed except by being at least partially destroyed. In general, any means using a device which can be inserted into place preventing full access to the keyhole, and which must be removed by at least compromising the device, is suitable as the seal of this invention. “Compromising” the seal includes such operations as breaking and bending; thus, the seal may have been compromised by being bent or broken, even though the keyhole may remain partially obstructed. Thus, the seal of this invention performs both an indicating function and a sealing function. Plastics can be engineered to have sufficient strength and insufficient elasticity (e.g., sufficiently brittle) that when used as a seal the seal must be broken to be removed, whereby access is evident. Other plastics and metals will have a change in their structure when bent, forming a crease or seam line, thereby evidencing their having been compromised. Accordingly, “compromise” can be defined as an insult to the integrity of the seal structure, even if such compromise does not affect its function as a seal. When the seal remains in place but the compromise is present and can be determined, tampering is evident. It should be understood that a seal could be provided which allows full access to the keyhole but prevents the key from being turned. “Access” to the keyhole as used herein includes not only the ability to place the key in the keyhole (and remove it therefrom), but also the ability to rotate the key to release the lock; and so “preventing access” includes at least one of preventing insertion of the key, removal of the key, and preventing the key from being turned effective to open the lock. Accordingly, it should be appreciated that the same degree of compromise may not be required to evidence tampering as that required to gain access to the lock.

The present invention is applicable to other keyed locks, including padlocks, door locks, and car locks. Each of those, or other, keyed locks would have a structure for retaining the seal in a manner such that the seal must be compromised for full access to the keyhole. In addition, the device is suitable for used with electronic locks (such as disclosed in U.S. Pat. No. 6,474,122, the disclosure of which is incorporated herein by reference, which locks are sold by Videx, Inc., Corvallis, Oreg.), keypad locks, biometric (e.g., optical or fingerprint) locks, card locks, and any lock wherein physical access to a mechanism is required. (For example, the present invention will not function with a magnetic lock unless the seal is constructed of material impermeable to magnet fields.) The present invention can also include a lock box (such as used by realtors to limit access to locked property being shown for sale or lease). For example, a locked box can be used to cover a door knob (which itself may or may not have a keyed lock) or prevent access to the keyed ignition of a vehicle or other device.

The foregoing description is meant to be illustrative and not limiting. Various changes, modifications, and additions may become apparent to the skilled artisan upon a perusal of this specification, and such are meant to be within the scope and spirit of the invention as defined by the claims.

What is claimed is:

1. A tamper-evident lock and seal combination, comprising:
A. a lock body housing a keyed lock for controlling the action of a moveable retainer, the keyed lock having a keyhole;
B. means on the lock body for permanently retaining a seal effective for preventing access to said keyhole; and
C. a seal removable from said retaining means only by being compromised, said compromise of the seal effective to evidence tampering.

2. The lock and seal combination of claim 1, wherein the lock is made of metal, plastic, or a combination thereof.

3. The lock and seal combination of claim 1, wherein the seal is made of metal or plastic or a combination thereof.

4. The lock and seal combination of claim 1, wherein the seal prevents inserting a key into the keyhole.

5. The lock and seal combination of claim 1, wherein the seal prevents a key inserted into the keyhole from being turned effective to open or secure the lock.

6. A method for providing evidence of tampering of a lock securing a device, comprising:
A. providing a lock body housing a keyed lock for controlling the action of a moveable retainer having a locked position and a released position, the retainer cooperating with a second portion of the lock effective to secure the device, the keyed lock having a keyhole;
B. providing a seal that cooperates with the lock body effective to prevent access to the keyed lock, and when said seal is compromised provides evidence of such compromise; and
C. securing the device with said lock and sealing the lock.

7. A security device for a keyed lock for access to an apparatus, comprising:
A. a keyed lock having a keyhole;
B. a housing for accepting a seal in relation to the keyhole effective to prevent access to the keyhole when the seal is in place; and
C. a seal that cooperates with the housing to prevent access to the keyhole, said cooperation requiring the seal to be compromised to provide access to the keyhole.

8. The device of claim 7, wherein the apparatus is a security bag.

9. The device of claim 7, wherein the lock is a padlock.

10. The device of claim 7, wherein the apparatus is a motor vehicle.

11. The device of claim 7, wherein the apparatus is a dwelling.

12. The device of claim 7, wherein the apparatus contains chemicals, pharmaceuticals, foodstuffs, cleaners, firearms, or alcoholic beverages.

13. The device of claim 7, wherein the seal prevents a key from being inserted into the keyhole.

14. The device of claim 7, wherein the seal prevents a key inserted into the keyhole from being turned effective to open or secure the lock.

15. A security device for a lock, comprising:
A. a lock body housing a lock that is locked or released by physical access to a portion of the lock body;
B. a seal interfering with said physical access, the seal evidencing compromise of the seal, and use of the lock provided by compromising the seal.

16. The device of claim 15, wherein the lock is selected from the group consisting of keyed locks, electronic locks, and keypad locks.

17. The device of claim 15, wherein the seal is made of metal, plastic, or a combination thereof.

18. The device of claim 15, wherein the security device is a lock box.

19. The device of claim 15, wherein the physical access is provided by a keyhole and the seal prevents access to the keyhole.

20. The device of claim 15, wherein the physical access is provided by a keyhole and the seal prevents a key inserted into the keyhole from being turned effective to open or secure the lock.
